(19) United States
(12) Patent Application Publication
(10) Pub. No.: US 2015/0267759 A1
(43) Pub. Date: Sep. 24, 2015

(54) ADJUSTMENT TAB FOR AN ADJUSTMENT MEANS OF A SELF-ADJUSTING CLUTCH AND A CLUTCH ASSEMBLY COMPRISING THE IMPROVED ADJUSTMENT TAB

(71) Applicant: Schaeffler Technologies AG & Co. KG, Herzogenaurach (DE)

(72) Inventors: Miguel Huerta Pérez, Puebla (MX); Sonia Betsabé Macías Espinosa, Puebla (MX); Geraldy Santiago Rosas, Puebla (MX)

(21) Appl. No.: 14/640,890

(22) Filed: Mar. 6, 2015

Related U.S. Application Data
(60) Provisional application No. 61/954,886, filed on Mar. 18, 2014.

(51) Int. Cl. F16D 13/75; F16D 13/42

(52) U.S. Cl. CPC F16D 13/757; F16D 13/42

(57) ABSTRACT

An improved adjustment tab for a self-adjusting clutch, comprising a base member having an integral engagement means operatively arranged to engage a clamp spring, the clamp spring operatively arranged to engage an adjustment means of the clutch; a first non-linear member emanating upwardly from the base member and arranged to clasp at least one of a plurality of lever arms; and, a second non-linear member emanating upwardly from the member and arranged to clasp at least one of the plurality of lever arms, and a clutch assembly which includes the improved adjustment tab.

### CROSS-REFERENCE TO RELATED APPLICATIONS

This application claims the benefit under 35 U.S.C. §119(e) of U.S. Provisional Patent Application No. 61/954,886, filed Mar. 18, 2014, which application is incorporated herein by reference in its entirety.

### TECHNICAL FIELD

The invention relates generally to clutch assemblies, and, more particularly, to an improved adjustment tab for an adjustment means within a clutch assembly.

### BACKGROUND

Clutch assemblies are used in motor vehicles between an engine and a transmission. A motor vehicle typically includes a single clutch or a dual clutch. In a motor vehicle with a single clutch, the clutch is coupled between the crankshaft and the input shaft of the transmission, thereby transferring torque from the crankshaft to the transmission. In a motor vehicle with a dual clutch, torque is transferred to two transmission input shafts arranged coaxially in relation to the other. Over time, the friction disc in the clutch assembly becomes increasingly worn. In order to compensate for the wear of the friction disc, the clutch assembly includes a means for adjusting the clutch assembly in relation to the amount of wear of the friction disc. The adjusting means includes at least one preloaded adjustment ring and a preloaded sensor ring with ramps provided between a clutch housing and lever arms. The adjustment and sensor rings are preloaded in a circumferential direction with pressure springs such that when the clutch disc becomes increasingly worn, the adjustment ring is forced to move in order to compensate the gap created between the pressure plate and the clutch disc.

The adjusting means is activated by sensor devices, which measure either travel or an actuating force exerted by the lever arms. The sensor devices include a clamp spring and adjustment tabs. The clamp spring is fixedly secured to the housing of the clutch assembly and operatively arranged to engage the adjustment tabs.

As described above, over time, the friction disc of the clutch assembly becomes worn; thus, the distance between the pressure plate and the friction disc increases. This increase in distance causes an increase in required engagement travel on the lever arms necessary to engage the pressure plate with the clutch disc. The adjustment tabs exert a predefined load on a sensor ring and sense the amount of wear or distance between the pressure plate and the friction disc. When the distance between the pressure plate and the friction disc increases, the lever arms engage the adjustment tab, then, the adjustment tab is lifted off, releasing the sensor ring. Since the adjustment tabs are also fixedly secured to the clamp spring, the axial movement of the lever arms causes the adjustment tabs and the clamp spring to undergo a travel or distance equal to the increase in distance between the pressure plate and the worn friction disc.

To compensate for the increased travel or distance between the adjustment tabs and the sensor ring, and thus an increase in the distance necessary for the pressure plate to engage with the friction disc, the sensor ring moves axially to reengage with the adjustment tabs. As the sensor ring reengages with the adjustment tabs, the adjuster ring simultaneously moves axially a distance equal to the distance traveled by the sensor ring. The adjustment means (comprising the adjuster ring, the sensor ring, the clamp spring, the adjustment tabs and the lever arms) moves axially a distance equivalent to that traveled by the adjuster ring and the sensor ring, such that the distance between the pressure plate and the friction disc returns to its initial predetermined equilibrium position.

A typical adjustment tab is disclosed in German Patent Application No. DE 102009053479 (Ruehle) filed Nov. 16, 2009. The clutch assembly disclosed includes an automatic readjusting device between the lever elements and the housing. The readjusting device described includes readjustment pieces which are secured to a sensor ring by rivets. However, due to the mass of the adjustment pieces and the structure of the assembly, unwanted rotation occurs.

Another adjustment tab is disclosed in German Patent Application No. DE 102011102261 (Miguel) filed May 23, 2011. The friction clutch disclosed in this application includes a diaphragm spring for actuating a pressure plate and an adjustment means secured to a clamping spring by a screw. However, due to the mass of the adjustment means and the structure of the assembly, unwanted rotation occurs.

The unwanted rotation described herein is demonstrated in FIGS. 2A through 4 which show a typical clutch assembly having a typical adjustment tab. Typical clutch assembly 40 rotates about axis 41 and broadly includes outer housing 42, central plate 43, adjuster ring 44, adjustment tabs 50A, 50B, and 50C, clamp spring 51, and sensor ring 54. Rivets 49B, 49F, and 49I secure clamp spring 51 and lever spring 57A to outer housing 42. Rivets 49A, 49C, 49D, 49E, 49G, and 49H secure lever spring 57B to central plate 43. Transport lock 58 is arranged proximate diaphragm spring 57B.

Typical adjustment tabs 50A, 50B, 50C are secured to clamp spring 51 by screws 52A, 52B, 52C, respectively, and bushings 53A (shown in FIG. 3C), 53B, and 53C, respectively. Although bushings 53B and 53C are not shown, it should be understood that they are identical to bushing 53A. FIGS. 3A, 3B, and 3C show typical adjustment tab 50A, screw 52A and bushing 53A, respectively, which are required to secure typical adjustment tab 50A to clamp spring 51. Typical adjustment tab 50A includes top portion 55, feet 56A and 56B, and aperture 60. The overall mass of adjustment tab 50A is approximately 3.79 grams. Top portion 55 rests atop clamp spring 51 when typical adjustment tab 50A is secured to clamp spring 51 and feet 56A and 56B surround clamp spring 51 (as shown in FIG. 4). Aperture 60 is arranged to receive screw 52A and bushing 53A. FIG. 3D shows the bottom of typical adjustment tab 50A.

When typical adjustment tab 50A and clamp spring 51 are secured together, clamp spring 51 exerts a downward force to the sensor ring 54. As best shown in FIG. 4, top portion 55 of typical adjustment tab 50A is positioned atop clamp spring 51; the same holds true for the other typical adjustment tabs 50B and 50C. Typical adjustment tab 50A and clamp spring 51 have center of mass A, which is too high. Specifically, center of mass A is approximately 4.60 mm from the optimal center of mass along the abscissa shown in FIG. 4 and approximately 1.90 mm from the optimal center of mass along the ordinate shown in FIG. 4.

Unfortunately, while clutch assembly 40 rotates about axis 41, due to the centrifugal force, each assembled typical adjustment tab 50A, 50B, 50C and clamp spring 51 produce an unwanted outward rotation in the direction of the arrow shown in FIG. 4. Instead of maintaining a level position atop sensor ring 54, the unwanted outward rotation causes each typical adjustment tab 50A, 50B, 50C and clamp spring 51 to tilt outwardly and downwardly. The mass of each typical adjustment tab 50A, 50B, 50C contributes to the unwanted rotation.

Thus, there has been a long-felt need for an improved adjustment tab for a clutch assembly which, when assembled with a clamp spring of the clutch assembly, reduces the amount of unwanted outward rotation.

### SUMMARY

The invention is a clutch assembly for transferring a torque between a flywheel of an engine and a transmission in a motor vehicle, the clutch assembly comprising a housing, a pressure plate fixedly secured to the housing, the pressure plate operatively arranged to cause a friction clutch disc to engage the flywheel, wherein the pressure plate is arranged for rotation about an axis of rotation, wherein the pressure plate is axially movable relative to the axis of rotation, an adjustment means operatively arranged to adjust travel of the pressure plate and the friction clutch disc, and a plurality of lever arms operatively arranged to provide a force within the clutch assembly, the adjustment means further comprising: an adjustment tab comprising: a base member having an integral engagement means operatively arranged to engage a clamp spring, the clamp spring operatively arranged to engage with the adjustment means of the clutch assembly; a first non-linear member emanating upwardly from the base member and arranged to clasp at least one of the plurality of lever arms; and, a second non-linear member emanating upwardly from the base member and arranged to clasp at least one of the plurality of lever arms.

The invention also includes an improved adjustment tab for a self-adjusting clutch comprising a base member having an integral engagement means operatively arranged to engage a clamp spring, the clamp spring operatively arranged to engage an adjustment means of the clutch; a first non-linear member emanating upwardly from the base member and arranged to clasp at least one of a plurality of lever arms; and, a second non-linear member emanating upwardly from the base member and arranged to clasp at least one of the plurality of lever arms.

Furthermore, the invention includes a clutch assembly for transferring a torque between a flywheel of an engine and a transmission in a motor vehicle, the clutch assembly comprising a housing, a pressure plate fixedly secured to the housing, the pressure plate operatively arranged to cause a friction clutch disc to engage the flywheel, wherein the pressure plate is arranged for rotation about an axis of rotation, wherein the pressure plate is axially movable relative to the axis of rotation, an adjustment means operatively arranged to adjust travel of the pressure plate and the friction clutch disc, and a plurality of lever arms operatively arranged to provide a force within the clutch assembly, the adjustment means further comprising an adjustment tab/clamp spring assembly including an adjustment tab coupled to a clamp spring, wherein the clamp spring is operatively arranged to engage the adjustment means of the clutch assembly, and wherein the adjustment tab/clamp spring assembly has a center of mass which is co-planar with the clamp spring.

Additionally, the invention includes an improved adjustment tab for a self-adjusting clutch comprising a base member having an integral engagement means operatively arranged to engage a clamp spring, the clamp spring operatively arranged to engage an adjustment means of the clutch, a first member emanating upwardly from the base member and arranged to clasp at least one of a plurality of lever arms, and, a second member emanating upwardly from the base member and arranged to clasp at least one of the plurality of lever arms.

A general object of the invention is to provide an improved adjustment tab for a clutch assembly which, when the improved adjustment tab is assembled with a clamp spring of the clutch assembly, results in a reduced amount of unwanted outward rotation.

A further object of the invention is to provide an improved adjustment tab which can be integrally secured to a clamp spring of a clutch assembly.

Another object of the invention is to provide an improved adjustment tab which has a reduced mass and, when the improved adjustment tab is coupled to a clamp spring of a clutch assembly, the improved adjustment tab and clamp spring exhibit an improved center of mass.

These and other objects, features and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2A is a perspective view of a clutch assembly having an adjustment tab;

FIG. 2B is a fragmentary view of the clutch assembly having the adjustment tab shown in FIG. 2A;

FIG. 3A is a perspective view of the prior art adjustment tab shown in FIG. 2A;

FIG. 3B is a perspective view of a screw of the prior art adjustment tab shown in FIG. 2A;

FIG. 3C is a perspective view of a bushing of the prior art adjustment tab shown in FIG. 2A;

FIG. 3D is a bottom plan view of the prior art adjustment tab shown in FIG. 3A;

FIG. 4 is a fragmentary cross-sectional view of the clutch assembly shown in FIG. 2B, taken generally along line 4-4 in FIG. 2B;

FIG. 5 is a perspective view of a clutch assembly having the improved adjustment tab of the invention;

FIG. 6 is a fragmentary view of the clutch assembly having the improved adjustment tab shown in FIG. 5;

FIG. 7A is a perspective view of the improved adjustment tab shown in FIG. 6;

FIG. 7B is a bottom plan view of the improved adjustment tab shown in FIG. 7A;

FIG. 8 is a fragmentary cross-sectional view taken generally along line 8-8 in FIG. 6;

FIG. 9 is a perspective view of a second embodiment of an improved adjustment tab according to the invention;

FIG. 10 is a perspective view of a third embodiment of an improved adjustment tab according to the invention;

FIG. 11 is a fragmentary view of a clutch assembly having the improved adjustment tab shown in FIG. 9;

FIG. 12 is a fragmentary view of a clutch assembly having the improved adjustment tab shown in FIG. 10;

FIG. 13 is a fragmentary cross-sectional view of the clutch assembly shown in FIG. 11, taken generally along line 13-13 in FIG. 11; and,

FIG. 14 is a fragmentary cross-sectional view of the clutch assembly shown in FIG. 12, taken generally along line 14-14 in FIG. 12.

### DETAILED DESCRIPTION

At the outset, it should be appreciated that like drawing numbers on different drawing views identify identical, or functionally similar, structural elements of the invention. It is to be understood that the invention as claimed is not limited to the disclosed aspects.

Furthermore, it is understood that this patent is not limited to the particular methodology, materials and modifications described and as such may, of course, vary. It is also understood that the terminology used herein is for the purpose of describing particular aspects only, and is not intended to limit the scope of the present invention as claimed.

Unless defined otherwise, all technical and scientific terms used herein have the same meaning as commonly understood to one of ordinary skill in the art to which this invention belongs. It should be understood that any methods, devices or materials similar or equivalent to those described herein can be used in the practice or testing of the invention.

The term “S”-shaped used herein refers to the general shape of non-linear members 113 and 114 and the term refers generally to the shape of a sigmoid curve. However, the term should not be so limited and non-linear members 113 and 114 can assume a variety of non-linear or linear shapes, for example, stepped shapes.

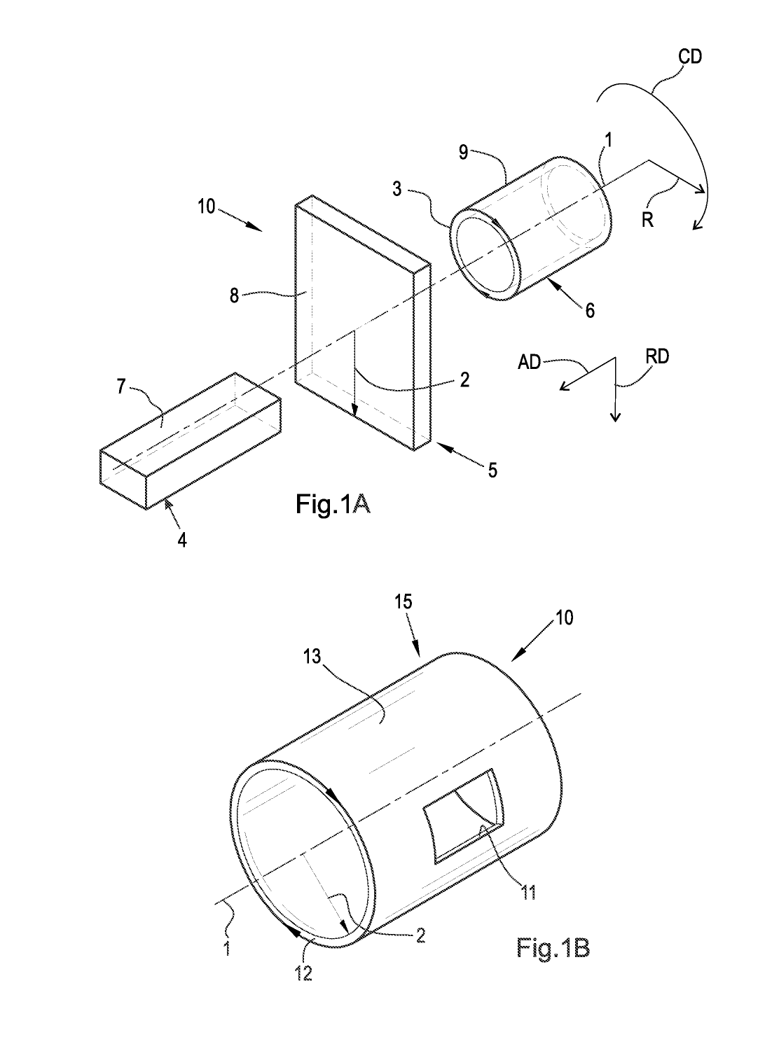

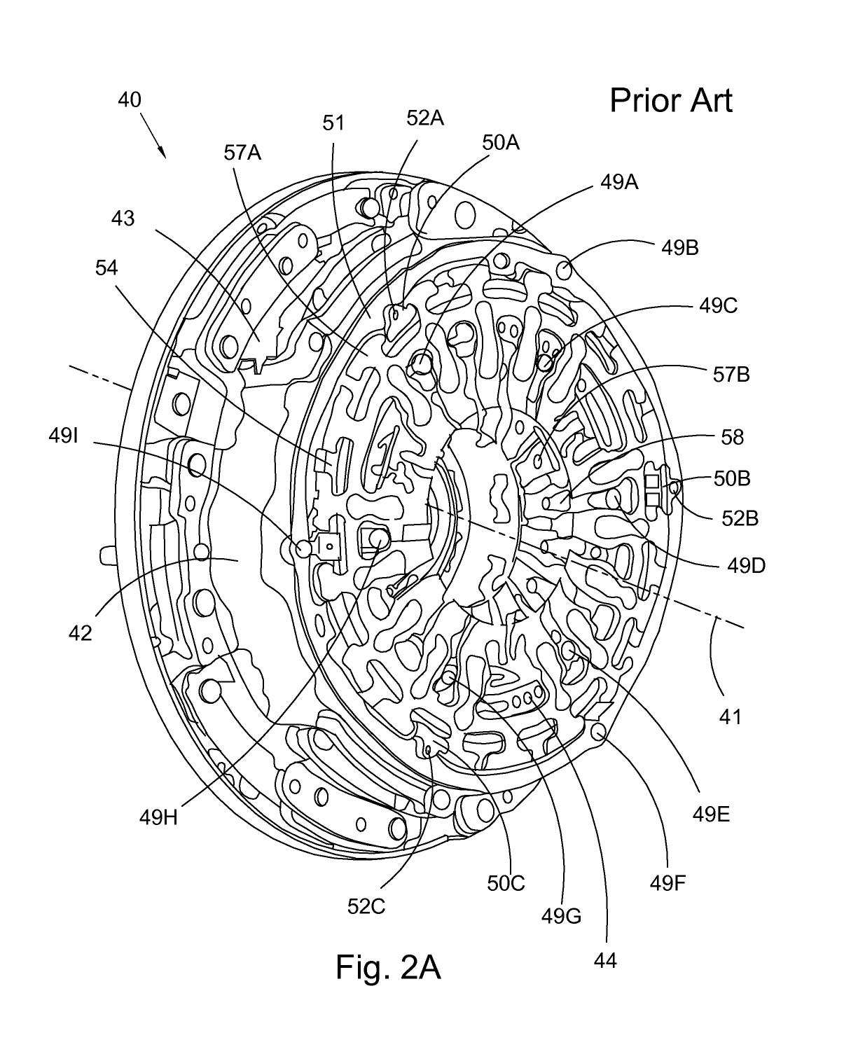

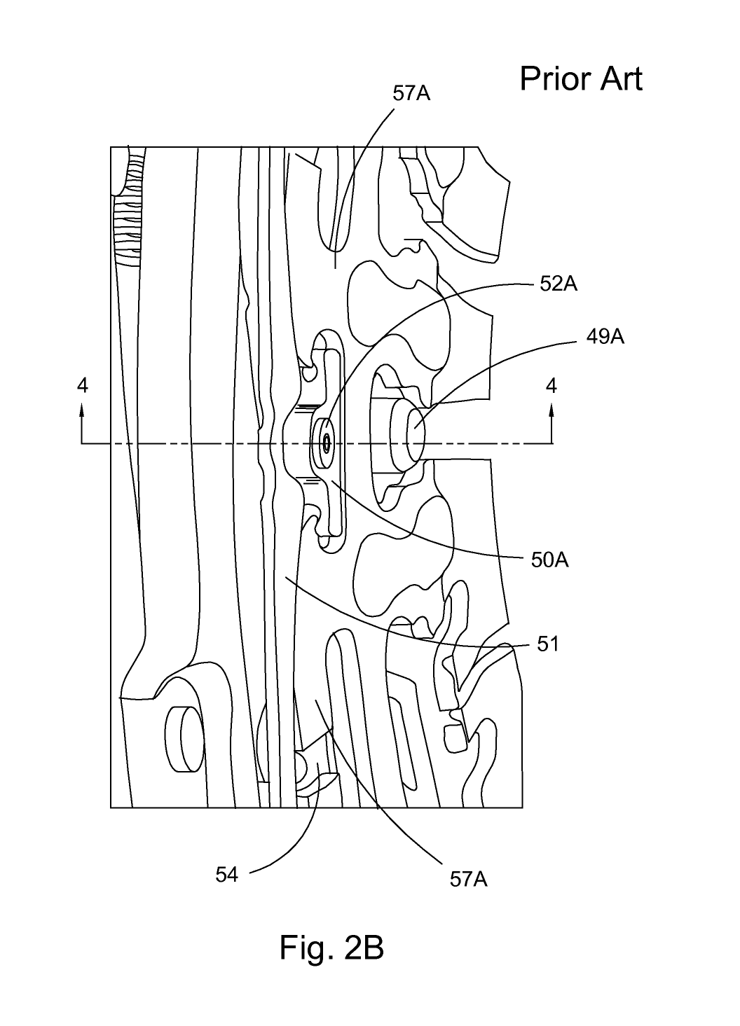

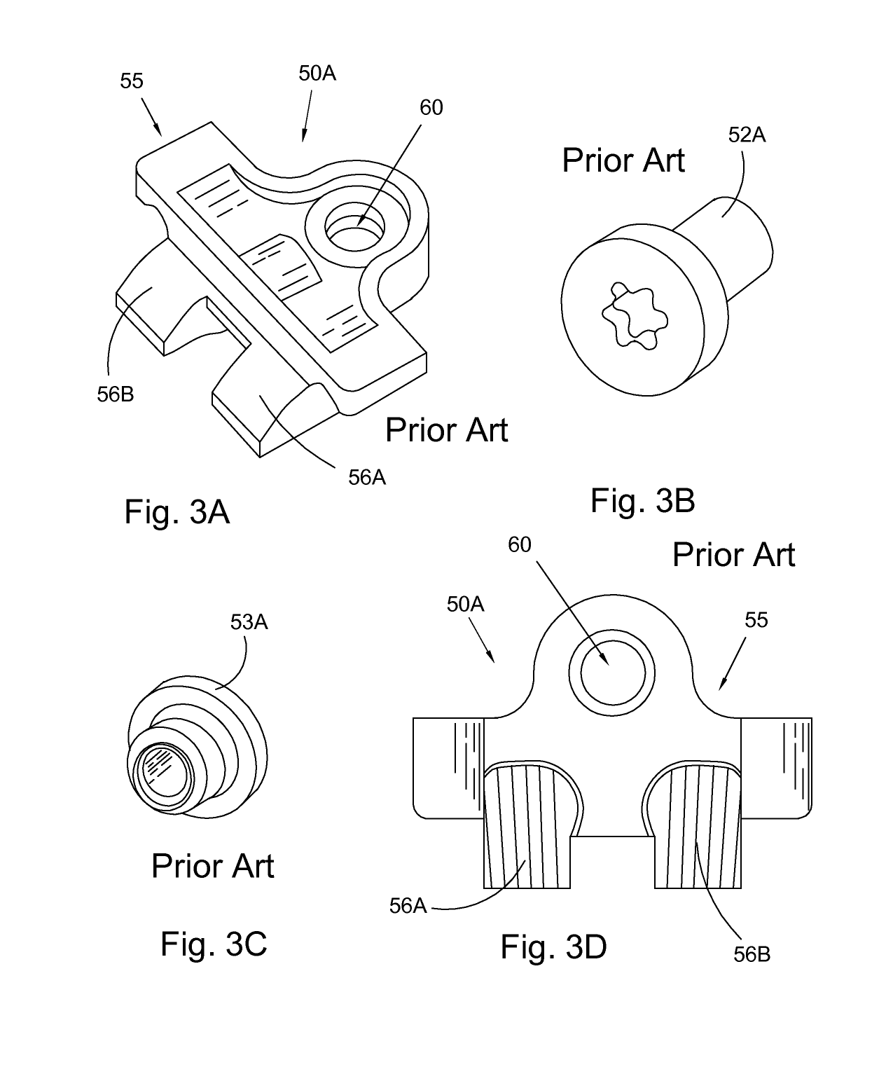

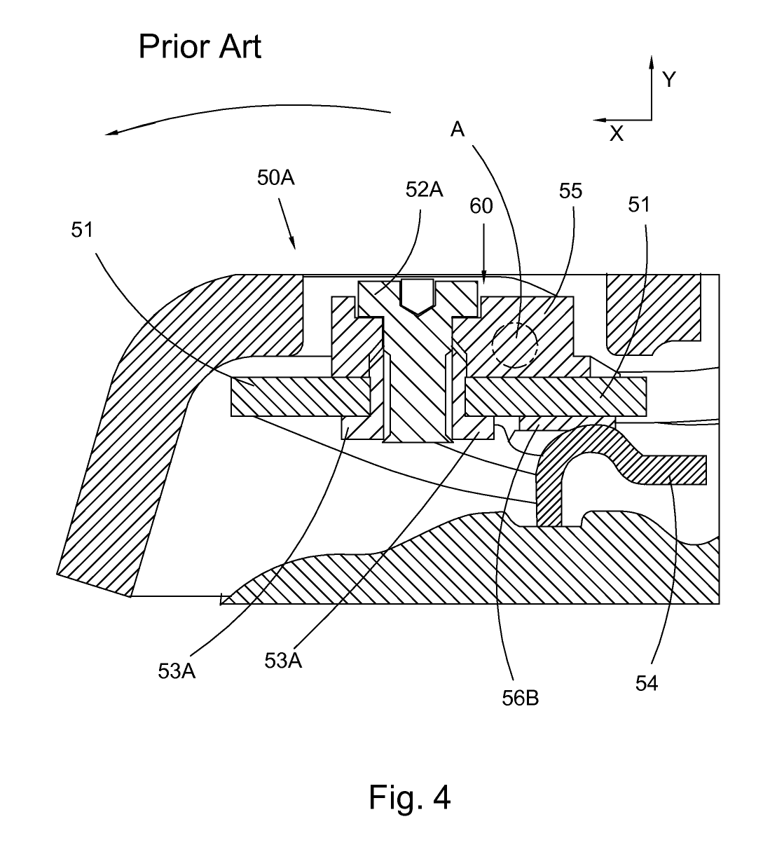

FIG. 1A is a perspective view of cylindrical coordinate system 10 demonstrating spatial terminology used in the present patent. The present invention is at least partially described within the context of cylindrical coordinate system 10. System 10 has a longitudinal axis 1, used as the reference for the directional and spatial terms that follow. Axial direction AD is parallel to axis 1. Radial direction RD is orthogonal to axis 1. Circumferential direction CD is defined by an endpoint of radius R (orthogonal to axis 1) rotated about axis 1.

To clarify the spatial terminology, objects 4, 5, and 6 are used. Surface 7 of object 4 forms an axial plane. For example, axis 1 is congruent with surface 7. Surface 8 of object 5 forms a radial plane. For example, radius 2 is congruent with surface 8. Surface 9 of object 6 forms a circumferential surface. For example, circumference 3 is congruent with surface 9. As a further example, axial movement or disposition is parallel to axis 1; radial movement or disposition is orthogonal to axis 2, and circumferential movement or disposition is parallel to circumference 3. Rotation is described herein with respect to axis 1.

The adverbs “axially,” “radially,” and “circumferentially” are used with respect to an orientation parallel to axis 1, radius 2, or circumference 3, respectively. The adverbs “axially,” “radially,” and “circumferentially” are also used with respect to orientation parallel to respective planes.

FIG. 1B is a perspective view of object 15 in cylindrical coordinate system 10 of FIG. 1A demonstrating spatial terminology used in the present patent. Cylindrical object 15 is representative of a cylindrical object in a cylindrical coordinate system and is not intended to limit the claims of the present invention in any manner. Object 15 includes axial surface 11, radial surface 12, and circumferential surface 13. Surface 11 is part of an axial plane; surface 12 is part of a radial plane, and surface 13 is part of a circumferential plane.

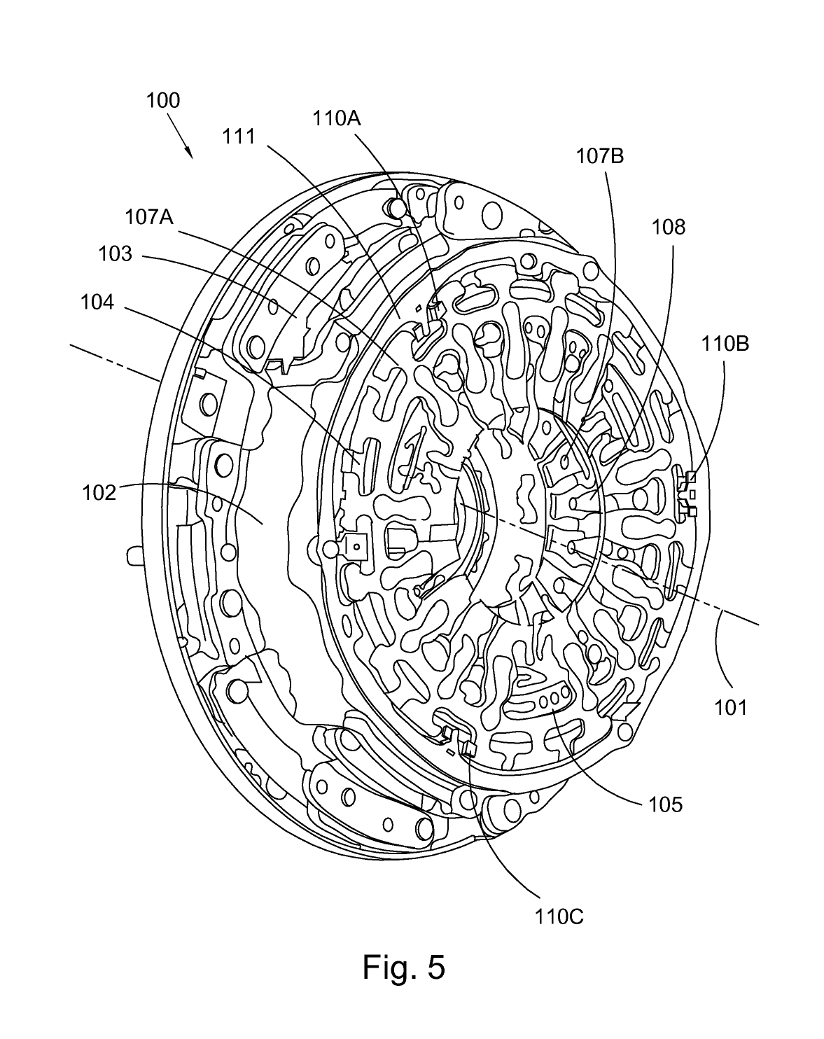

FIGS. 5 through 8 show clutch assembly 100 including improved adjustment tabs 110A, 110B, and 110C which are substantially similar. The description of improved adjustment tab 110A applies to improved tabs 110B and 110C. Clutch assembly 100 is rotatable about axis 101. Clutch assembly 100 broadly includes outer housing 102, central plate 103, sensor ring 104, adjuster ring 105, lever spring 107A, lever spring 107B, improved adjustment tabs 110A, 110B, and 110C, and clamp spring 111. Notably, adjustment tabs 110A, 110B, and 110C engage clamp spring 111 without any screws and bushings or rivets. Clamp spring 111 exerts a downward force to the sensor ring 104.

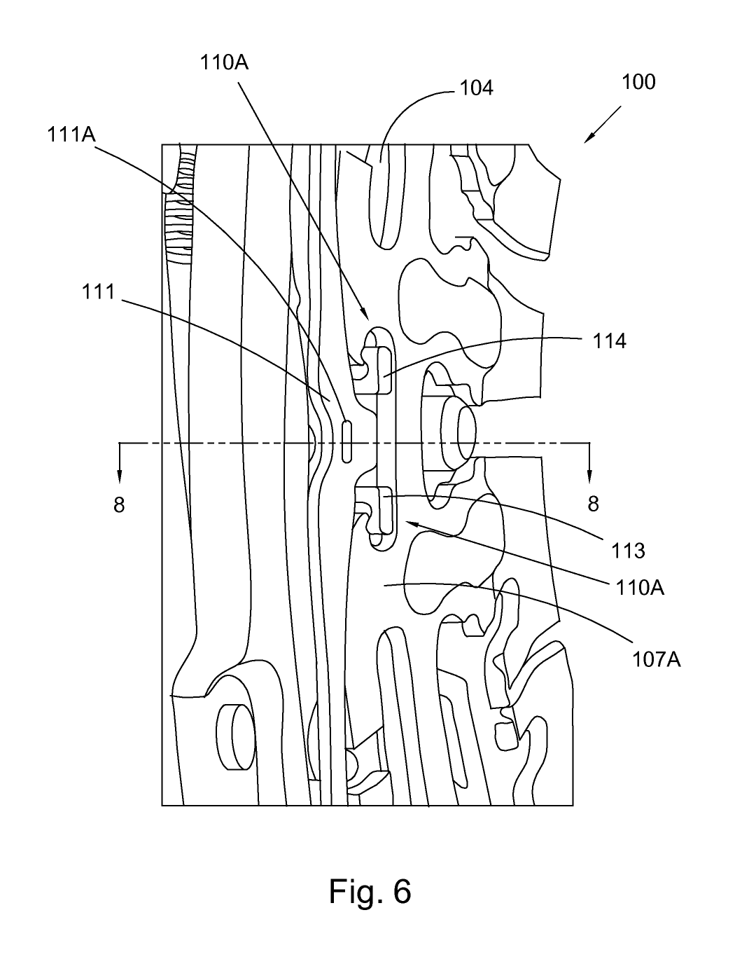

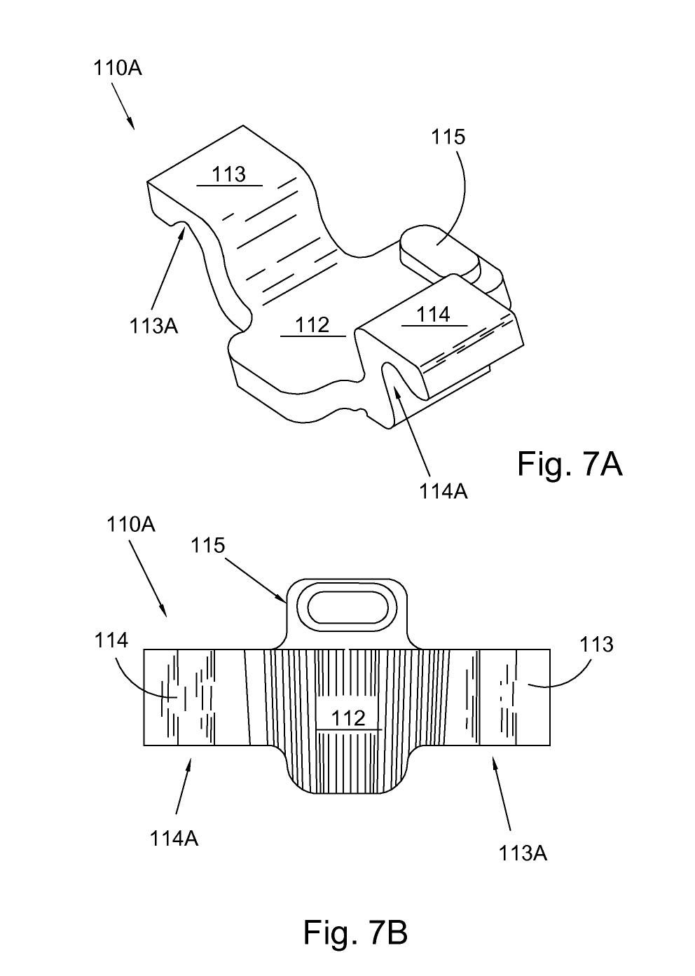

In FIG. 6, non-linear members 113 and 114 of improved adjustment tab 110A are each arranged to clasp at least one lever arm of lever spring 107A. In FIG. 6, base portion 112 and extension 115 are behind clamp spring 111. FIG. 7A shows a perspective view of improved adjustment tab 110A which includes base portion 112, non-linear member 113, non-linear member 114 and extension 115. Base portion 112 is substantially planar to contact the underneath surface of clamp spring 111. In a preferred embodiment, base portion 112 is substantially cuboid in shape with rounded edges. Extension 115 protrudes upwardly or radially from base portion 112 to fit within correspondingly shaped aperture 111A of clamp spring 111. Non-linear members 113 and 114 emanate or radiate from opposing sides of base portion 112 in a direction orthogonal to the position of extension 115. Non-linear member 113 mirrors non-linear member 114. As described above, non-linear members 113 and 114 are substantially “S”-shaped. Preferably, improved adjustment tab 110A is stamped of a single piece of material, for example, sheet metal.

Due to the “S”-shape of non-linear members 113 and 114, non-linear members 113 and 114 could have a spring-like force when a load is applied to them. This spring-like force could help secure improved adjustment tabs 110A, 110B, and 110C to clamp spring 111. Since base portion 112 has a width that is less than the width of clamp spring 111, non-linear members 113 and 114 apply a force back onto clamp spring 111.

FIG. 7B shows a bottom plan view of improved adjustment tab 110A. Base portion 112 is substantially planar while non-linear members 113 and 114 are arcuate. Extension 115 is shown stamped inward; in FIG. 7A, extension 115 is shown stamped upward. Non-linear members 113 and 114 are arm-like and operatively arranged to engage lever spring 107A (shown in FIG. 6) via hooks 113A and 114A. The overall mass of improved adjustment tab 110A is approximately 2.15 grams, although it should be appreciated that the mass of improved adjustment tab 110A may vary and is not intended to limit the scope of the claims. To install improved adjustment tab 110A onto clamp spring 111, a person would pull clamp spring 111 upwards and slide improved adjustment tab 110A onto clamp spring 111 until extension 115 fits within correspondingly shaped aperture 111A of clamp spring 111.

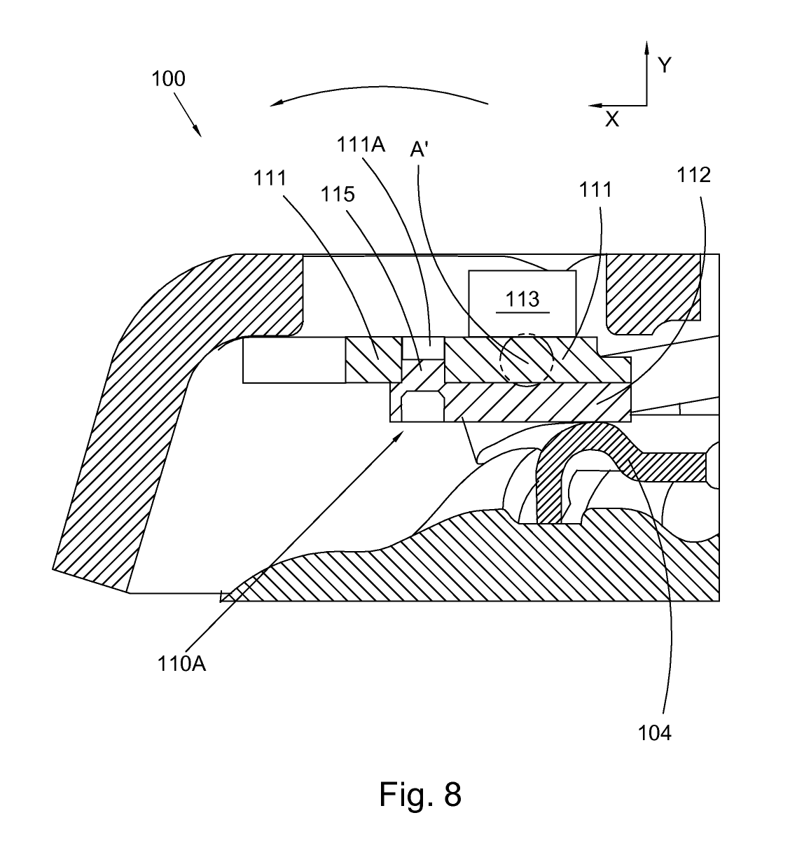

As shown in FIG. 8, clamp spring 111 includes correspondingly shaped aperture 111A to accommodate extension 115 of improved adjustment tab 110A. Improved adjustment tab 110A is integrally engaged with clamp spring 111. In a preferred embodiment, extension 115 has a shape that is rounded rectangular and aperture 111A is correspondingly shaped. When improved adjustment tab 110A is secured to clamp spring 111, the adjustment tab/clamp spring assembly has center of mass A′, which is co-planar with clamp spring 111. Specifically, center of mass A′ is approximately 4.74 mm from the optical center of mass along the abscissa shown in FIG. 8 and approximately −0.016 mm from the optical center of mass along the ordinate shown in FIG. 8. Due to the arrangement of improved adjustment tab 110A and clamp spring 111, while clutch assembly 100 rotates about axis 101, there is a significant reduction in the amount of unwanted outward rotation in the direction of the arrow shown in FIG. 8. The reduced mass of improved adjustment tab 110A contributes to this reduction of unwanted outward rotation.

Improved adjustment tab 210A is illustrated in FIGS. 9, 11 and 13. The description regarding improved adjustment tab 110A applies to improved adjustment tab 210A except as provided. Non-linear members 213 and 214 each include an additional arcuate portion on the end opposite base portion 212. The mass of improved adjustment tab 210A is approximately 1.94 grams, although it should be appreciated that the mass of improved adjustment tab 210A may vary and is not intended to limit the scope of the claims.

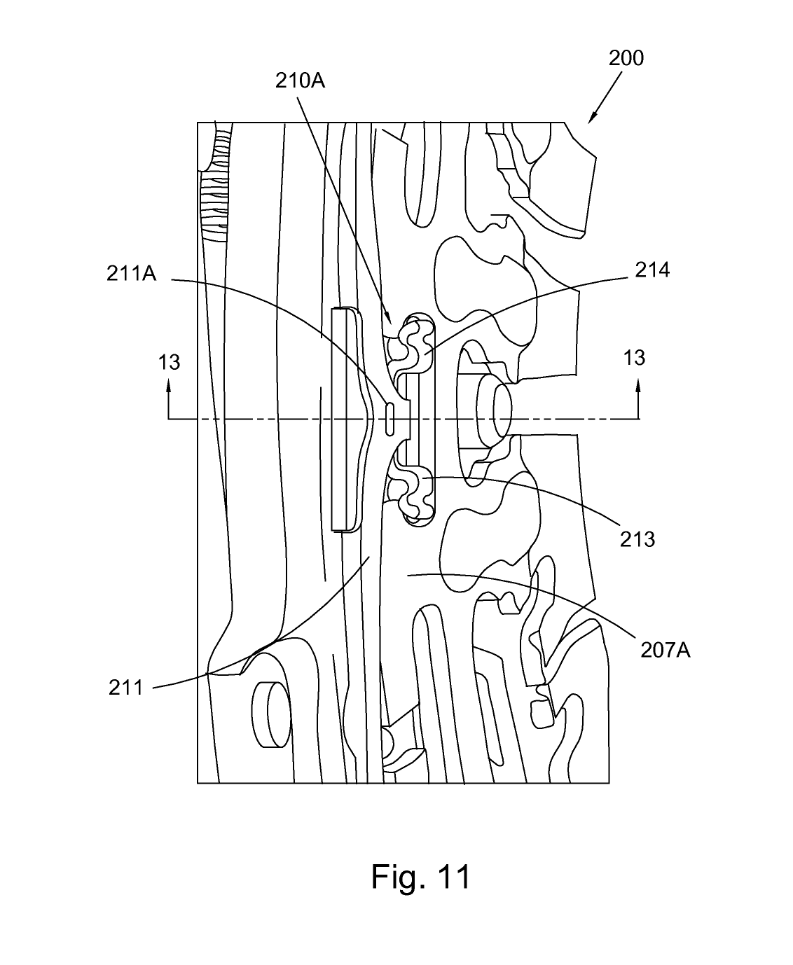

FIG. 11 depicts improved adjustment tab 210A within a portion of clutch assembly 200. Non-linear members 213 and 214 are each arranged to clasp at least one of a plurality of lever arms 207A. Clamp spring 211 includes aperture 211A to accommodate extension 215. Base portion 212 rests beneath clamp spring 211.

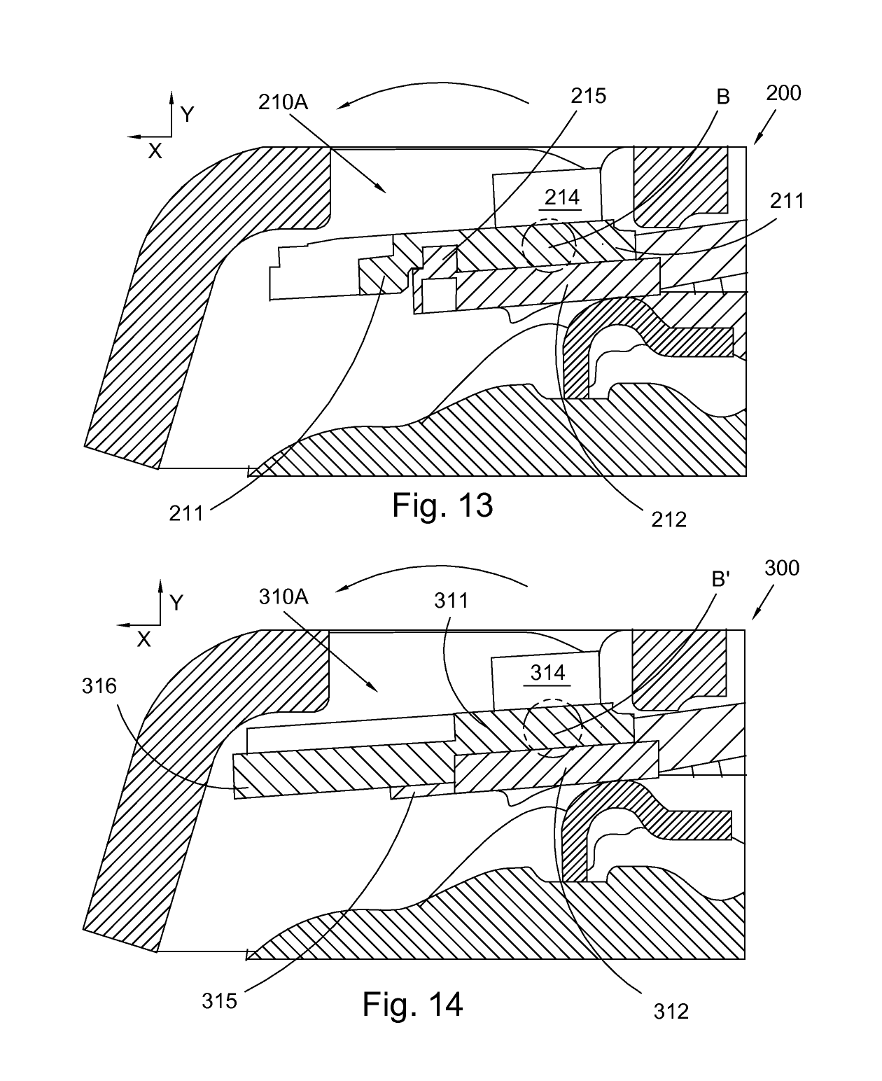

When improved adjustment tab 210A is secured to clamp spring 211 (as shown in FIG. 13), center of mass B is positioned approximately 4.74 mm from the optimal center of mass along the abscissa shown and approximately 0.05 mm from the optimal center of mass along the ordinate shown.

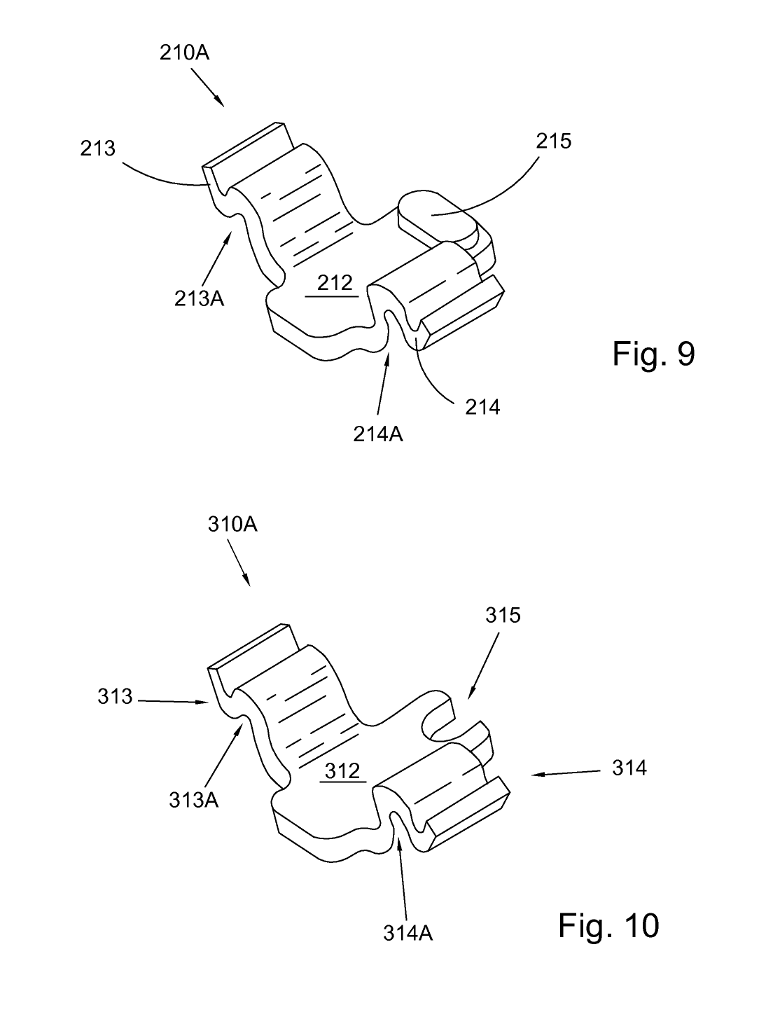

Improved adjustment tab 310A is shown in FIGS. 10, 12 and 14. The descriptions regarding improved adjustment tabs 110A and 210A apply to improved adjustment tab 310A except as provided. Instead of an extension, improved adjustment tab 310A includes “U”-shaped opening 315.

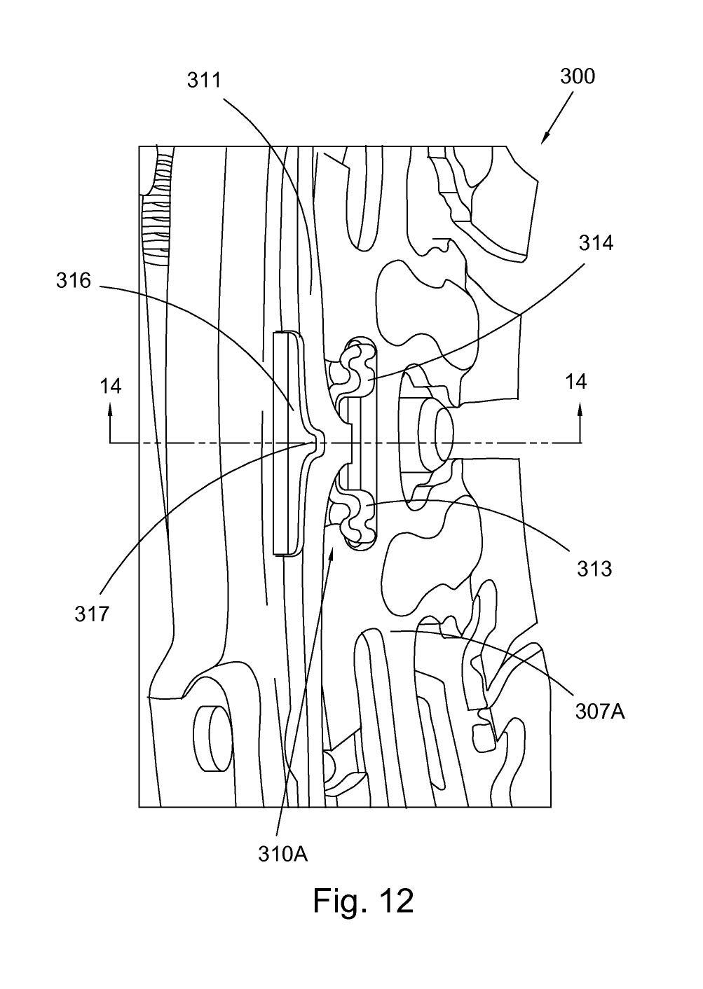

FIG. 12 shows improved adjustment tab 310A secured to clamp spring 311 within a portion of clutch assembly 300. Base portion 312 and “U”-shaped opening 315 are obscured by clamp spring 311. Clamp spring 312 includes recessed portion 316 which includes protrusion 317. Recessed portion 316 and protrusion 317 are arranged to engage “U”-shaped opening 315 of improved adjustment tab 310A. Additionally, recessed portion 316 and protrusion 317 provide centering for the improved adjustment tab 310A. Non-linear members 313 and 314 are each arranged to clasp at least one of a plurality of lever arms 307A.

The overall mass of improved adjustment tab 310A is approximately 1.94 grams although it should be appreciated that the mass of improved adjustment tab 310A may vary and is not intended to limit the scope of the claims. When improved adjustment tab 310A is secured to clamp spring 311 (as shown in FIG. 14), center of mass B′ is positioned approximately 4.72 mm from the optimal center of mass along the abscissa shown and approximately 0.01 mm from the optimal center of mass along the ordinate shown.

A clutch assembly incorporating improved adjustment tabs 110A, 210A, 310A can be actuated via electric or hydraulic means.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

40 typical clutch assembly
41 axis
42 outer housing
43 central plate
44 adjuster ring
49A rivet
49B rivet
49C rivet
49D rivet
49E rivet
49F rivet
49G rivet
49H rivet
49I rivet
50A prior art adjustment tab
50B prior art adjustment tab
50C prior art adjustment tab
51 clamp spring
52A screw
52B screw
52C screw
53A bushing
54 sensor ring
55 top
56A foot
56B foot
57A lever spring
57B lever spring
58 transport lock
60 aperture
A center of mass
A′ center of mass
B center of mass
B′ center of mass
X abscissa
Y ordinate
100 clutch assembly
101 axis
102 outer housing
103 central plate
104 tension ring
105 adjuster ring
107A lever spring
107B lever spring
108 transport lock
110A improved adjustment tab
110B improved adjustment tab
110C improved adjustment tab
111 clamp spring
111A aperture
112 base portion
113 non-linear member
114 non-linear member
115 extension
200 clutch assembly
210A adjustment tab
207A lever arms
211 clamp spring
211A aperture
212 base portion
213 non-linear member
213A hook
214 non-linear member
214A hook
215 extension
300 clutch assembly
307A lever arms
311 clamp spring
310A adjustment tab
312 base portion
313 non-linear member
313A hook
314 non-linear member
314A hook
315 “U” shaped opening
316 recessed portion
317 protrusion

What we claim is:

1. A clutch assembly for transferring a torque between a flywheel of an engine and a transmission in a motor vehicle, said clutch assembly comprising a housing, a pressure plate fixedly secured to said housing, said pressure plate operatively arranged to cause a friction clutch disc to engage said flywheel, wherein said pressure plate is arranged for rotation about an axis of rotation, wherein said pressure plate is axially movable relative to said axis of rotation, an adjustment means operatively arranged to adjust travel of said pressure plate and said friction clutch disc, and a plurality of lever arms operatively arranged to provide a force within said clutch assembly, said adjustment means further comprising:
an adjustment tab comprising:
a base member having an integral engagement means operatively arranged to engage a clamp spring, said clamp spring operatively arranged to engage with said adjustment means of said clutch assembly;
a first non-linear member emanating upwardly from said base member and arranged to clasp at least one of said plurality of lever arms; and,
a second non-linear member emanating upwardly from said base member and arranged to clasp at least one of said plurality of lever arms.

2. The clutch assembly recited in claim 1, wherein said integral engagement means includes an extension and said clamp spring includes a correspondingly shaped aperture operatively arranged to engage said extension.

3. The clutch assembly recited in claim 1, wherein said integral engagement means includes a substantially “U”-shaped opening and said clamp spring includes a correspondingly shaped protrusion arranged to engage said opening.

4. The clutch assembly recited in claim 1, wherein said adjustment tab is stamped of a single piece of material.

5. The clutch assembly recited in claim 2, wherein said extension and said correspondingly shaped aperture are rounded rectangular in shape.

6. The clutch assembly recited in claim 2, wherein said first and second non-linear members are substantially “S”-shaped.

7. The clutch assembly recited in claim 2, wherein said first non-linear member mirrors said second non-linear member.

8. The clutch assembly recited in claim 2, wherein said base member is substantially planar.

9. The clutch assembly recited in claim 2, wherein said first and second non-linear members emanate upwardly from opposing sides of said base member.

10. The clutch assembly recited in claim 3, wherein said first and second non-linear members are substantially “S”-shaped.

11. The clutch assembly recited in claim 3, wherein said first non-linear member mirrors said second non-linear member.

12. The clutch assembly recited in claim 3, wherein said base member is substantially planar.

13. The clutch assembly recited in claim 3, wherein said first and second non-linear members emanate upwardly from opposing sides of said base member.

14. The clutch assembly recited in claim 1 further comprising an electric motor to provide an actuation means for engaging and disengaging said pressure plate and said friction disc.

15. The clutch assembly recited in claim 1 further comprising a hydraulic motor to provide an actuation means for engaging and disengaging said pressure plate and said friction disc.

16. An improved adjustment tab for a self-adjusting clutch, comprising:
a base member having an integral engagement means operatively arranged to engage a clamp spring, said clamp spring operatively arranged to engage an adjustment means of said clutch;
a first non-linear member emanating upwardly from said base member and arranged to clasp at least one of a plurality of lever arms; and,
a second non-linear member emanating upwardly from said base member and arranged to clasp at least one of said plurality of lever arms.

17. A clutch assembly for transferring a torque between a flywheel of an engine and a transmission in a motor vehicle, said clutch assembly comprising a housing, a pressure plate fixedly secured to said housing, said pressure plate operatively arranged to cause a friction clutch disc to engage said flywheel, wherein said pressure plate is arranged for rotation about an axis of rotation, wherein said pressure plate is axially movable relative to said axis of rotation, an adjustment means operatively arranged to adjust travel of said pressure plate and said friction clutch disc, and a plurality of lever arms operatively arranged to provide a force within said clutch assembly, said adjustment means further comprising:
an adjustment tab/clamp spring assembly including an adjustment tab coupled to a clamp spring, wherein said clamp spring is operatively arranged to engage said adjustment means of said clutch assembly, and wherein said adjustment tab/clamp spring assembly has a center of mass which is co-planar with the clamp spring.

18. The clutch assembly recited in claim 17, wherein said adjustment tab includes an extension and said clamp spring includes a correspondingly shaped aperture operatively arranged to engage said extension.

19. The clutch assembly recited in claim 17, wherein said adjustment tab includes a substantially “U”-shaped opening and said clamp spring includes a correspondingly shaped protrusion arranged to engage said opening.

20. The clutch assembly recited in claim 17, wherein said adjustment tab is stamped of a single piece of material.

21. An improved adjustment tab for a self-adjusting clutch, comprising:
a base member having an integral engagement means operatively arranged to engage a clamp spring, said clamp spring operatively arranged to engage an adjustment means of said clutch;
a first member emanating upwardly from said base member and arranged to clasp at least one of a plurality of lever arms; and,
a second member emanating upwardly from said base member and arranged to clasp at least one of said plurality of lever arms.
